(19) United States
(12) Patent Application Publication
(10) Pub. No.: US 2010/0054143 A1
(43) Pub. Date: Mar. 4, 2010

(54) UPLINK CONNECTIVITY FOR MOBILE CLIENTS

(75) Inventors: Ravindranath Kokku, Monmouth Junction, NJ (US); Kishore Ramachandran, North Brunswick, NJ (US); Karthikeyan Sundaresan, Howell, NJ (US)

Correspondence Address: NEC LABORATORIES AMERICA, INC., 4 INDEPENDENCE WAY, Suite 200, PRINCETON, NJ, 08540, US

(73) Assignee: NEC Laboratories America, Inc., Princeton, NJ (US)

(21) Appl. No.: 12/499,871

(22) Filed: Jul. 9, 2009

Related U.S. Application Data
(60) Provisional application No. 61/092,442, filed on Aug. 28, 2008.

(51) Int. Cl. H04L 12/26; H04B 7/005

(52) U.S. Cl. 370/252; 370/310

(57) ABSTRACT

Methods and apparatus are provided for uplink connectivity for mobile clients. An apparatus in a mobile client includes an antenna for transmitting and receiving wireless signals, and an uplink connectivity manager for dividing an uplink transmission for each client location into an exploration phase and an operational phase.

### RELATED APPLICATION INFORMATION

This application claims priority to provisional application Ser. No. 61/092,422 filed on Aug. 28, 2008, incorporated herein by reference.

### BACKGROUND

1. Technical Field

The present invention relates to mobile communications, and more particularly to uplink connectivity for mobile clients.

2. Description of the Related Art

In a wireless network, the mobile uplink is the connection between a mobile device and one or more base stations of the wireless network. Due to emerging applications such as mobile P2P, data backup for videos and images collected by mobile devices, and so forth, it would be advantageous to increase the mobile uplink throughput. However, the scarcity of wireless spectrum has only served to compound the problem of less than adequate mobile uplink throughput for some applications.

One class of solutions uses switched-beam directional antennas on the client in order to implement focused transmit beams to increase the signal to noise ratio (SNR) on the link from the client to a single base station. These solutions are referred to as directionality-based solutions.

Another class of solutions uses omni-directional transmission on the client and combines packets received at all the receivers visible to the client, assuming that there are multiple receivers of a wireless network available around the client. These solutions are referred to as diversity-based solutions.

However, taken by themselves, each of the directionality-based solutions and the diversity-based solutions suffer from a number of deficiencies. For example, each solution taken in isolation often provides less than the optimal solution, thus providing room for further improvement in the obtained uplink throughput.

### SUMMARY

These and other drawbacks and disadvantages of the prior art are addressed by the present principles, which are directed to uplink connectivity for mobile clients.

According to an aspect of the present principles, there is provided an apparatus in a mobile client. The apparatus includes an antenna for transmitting and receiving wireless signals, and an uplink connectivity manager for dividing an uplink transmission for each client location into an exploration phase and an operational phase.

According to another aspect of the present principles, there is provided a system. The system includes one or more mobile clients, each having an uplink connectivity manager for dividing an uplink transmission for each client location into an exploration phase and an operational phase. The system further includes a server for providing support to the one or more mobile devices with respect to the exploration phase and the operational phase, by at least receiving an estimated uplink throughout performance, for each client location, as reported by each of the one or more mobile clients with respect to the exploration phase, and indicating to each of the one or more mobile clients a respective parameter settings set to try at at least a current location with respect to the operational phase. Each of parameter settings in the respective parameter settings set are determined to be the best available based on one or more thresholds.

According to yet another aspect of the present principles, there is provided a method performed in a wireless network having one or more mobile clients and a server. The method includes dividing, in each of the one or more mobile clients, an uplink transmission for each client location into an exploration phase and an operational phase. The method further includes providing support to the one or more mobile devices by the server with respect to the exploration phase and the operational phase, by at least receiving an estimated uplink throughout performance, for each client location, as reported by each of the one or more mobile clients with respect to the exploration phase, and indicating to each of the one or more mobile clients a respective parameter settings set to try at at least a current location with respect to the operational phase. Each of parameter settings in the respective parameter settings set are determined to be the best available based on one or more thresholds.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram showing a communication system 100 to which the present principles may be applied, in accordance with an embodiment of the present principles;

FIG. 2 is a diagram showing the exploration phase 200 of the client 131, in accordance with an embodiment of the present principles; and

FIG. 3 is a diagram showing the operational phase 300 of the client 131, in accordance with an embodiment of the present principles.

### DETAILED DESCRIPTION OF PREFERRED EMBODIMENTS

The present principles are directed to a system and method for intelligently combining directionality and diversity, and tuning the bit rate, to maximize the uplink throughput of a client. In an embodiment, the client chooses an appropriate subset of the receivers, a suitable transmission beam that covers the chosen receivers, and an appropriate bit rate to make packets decodeable at each of the receivers.

Advantageously, it is to be appreciated that the present principles provide higher uplink throughput and longer duration of uplink connectivity that will be useful for various wireless networks, which are constrained by increased uplink bandwidth requirements due to emerging applications such as mobile P2P, data backups such as videos and images from mobile devices, and so forth.

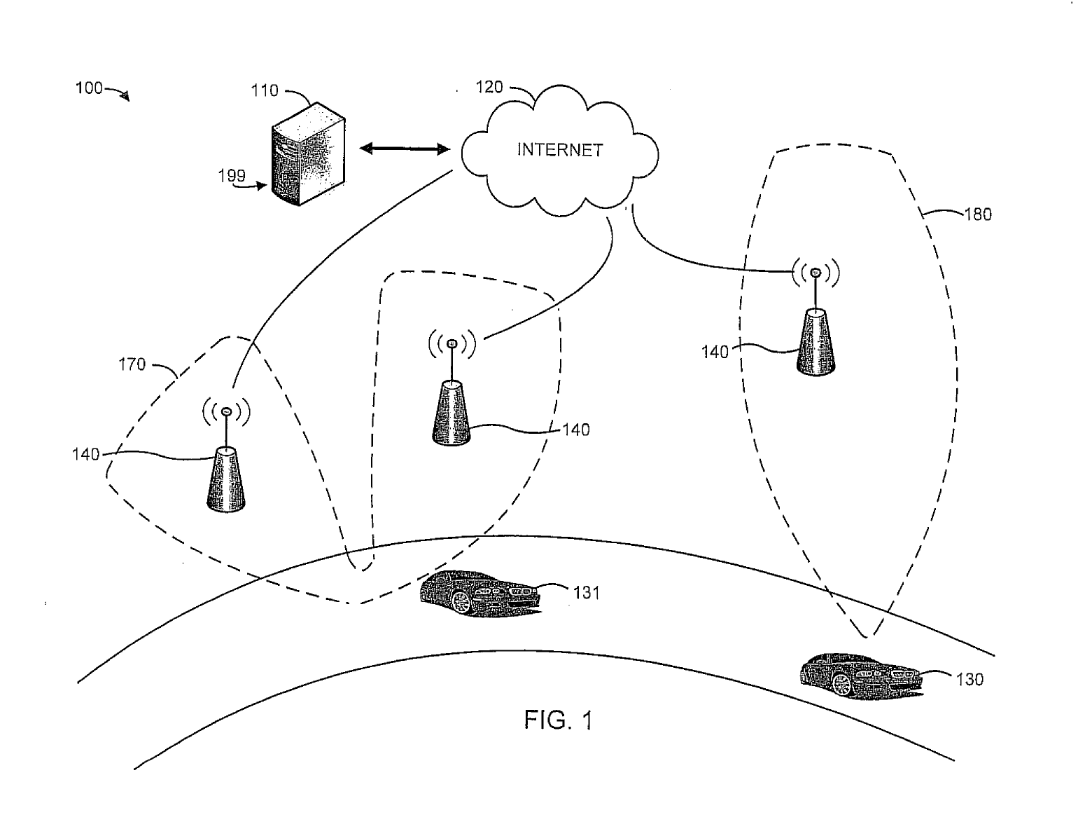

Referring now in detail to the figures in which like numerals represent the same or similar elements and initially to FIG. 1, a communication system 100 to which the present principles may be applied, in accordance with an embodiment of the present principles is shown. The communication system 100 includes a server 110, one or more networks 120 (in the illustrative example, the networks 120 are represented by the Internet), mobile clients 131 and 132 (hereinafter also interchangeably referred to as “client” for short), and a set of receivers 140. Client 131 advantageously utilizes an approach to uplink connectivity in accordance with an embodiment of the present principles, while client 132 disadvantageously utilizes an approach to uplink connectivity that only exploits directionality. Hence, for the sake of illustration of the present principles, client 131 will primarily be discussed hereinafter. Of course, it is to be appreciated that while client 131 is shown in FIG. 1 and described with respect to an embodiment of the present principles, other embodiments of the present principles may include more than one client capable of implementing the present principles, while maintaining the spirit of the present principles.

A client 131 connects to other nodes in the Internet (for various applications such as P2P and file transfer) through wireless connection with one or more of the receivers. The wireless connection is represented by different beams shown in FIG. 1. In particular, beam 170 exploits directionality and diversity, while beam 180 exploits only directionality.

In an embodiment, the server 110 maintains a database of information for each client location of (1) the best subset of receivers and their positions, and (2) the appropriate bit rate for the given subset of receivers. Hereinafter, we collectively refer to the preceding information in the database as “resource parameter settings”. Of course, it is to be appreciated that the present principles are not limited to the only the preceding types of information as forming the resource parameter settings and, thus, other types of information may be used in conjunction with and/or in place of the preceding described information in order to form the resource parameter settings, while maintaining the spirit of the present principles.

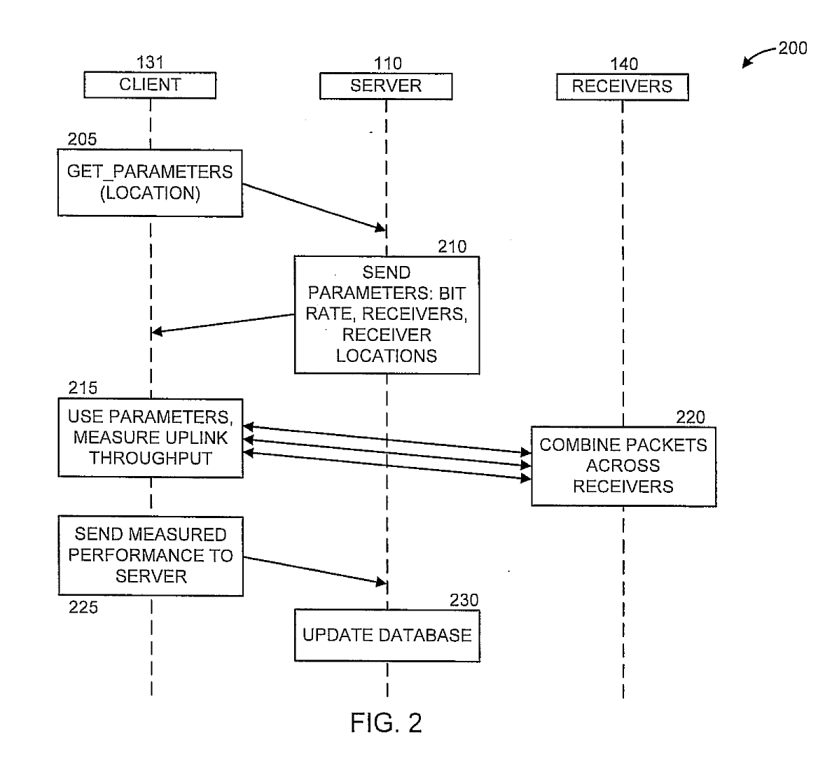

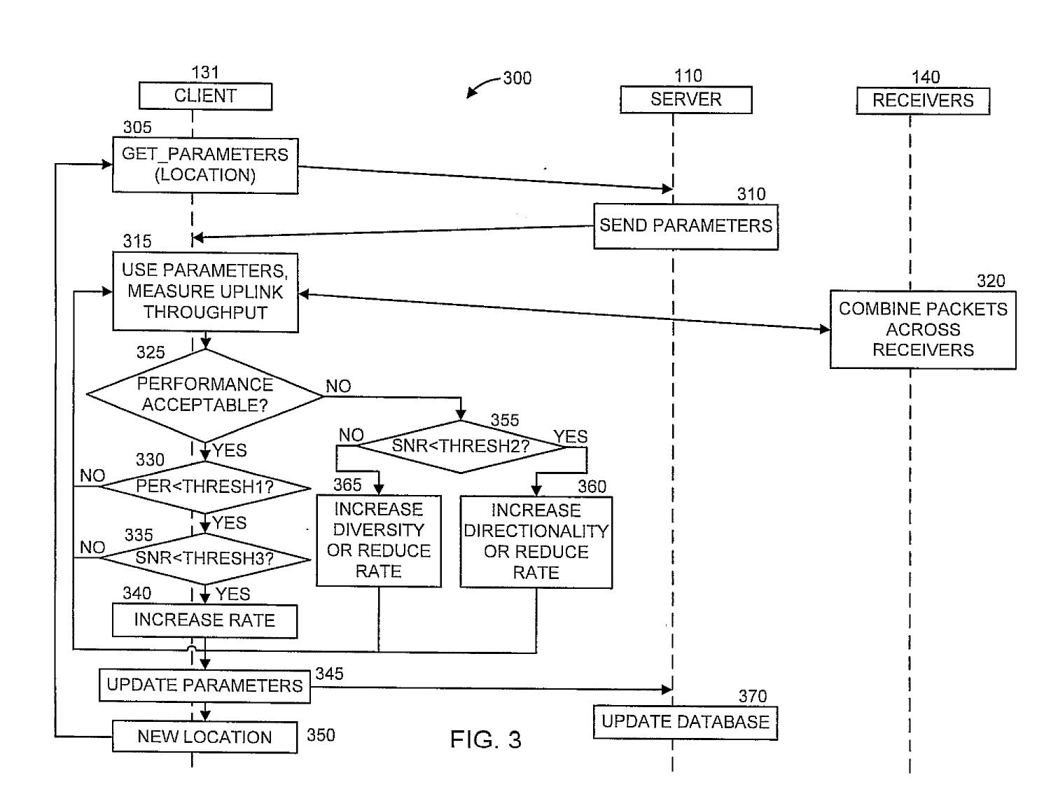

For the subset of receivers 140, based on its position and the positions of the receivers, the client 131 determines an optimal beam using multiple antenna technology. In an embodiment, the client 131 operates in two phases, namely an exploration phase (described in further detail herein below with respect to FIG. 2) and an operational phase (described in further detail herein below with respect to FIG. 3). During a period of time referred to as the exploration phase, the server 110 instructs each client 131 to explore resource parameter settings for which the performance is not yet known to the server 110 in order to learn appropriate resource parameter settings per location. The client 131 returns the performance obtained and the server 110 updates the database. In the client 131, an uplink manager 199 operates and/or otherwise manages the exploration phase and the operational phase. In an embodiment, the uplink manager 199 includes at least a processor and corresponding memory. The memory may be used to store, among other things, parameter settings (e.g., bit rate, a group of receivers, and the locations of the receivers within the group) relating to uplink throughput performance for a plurality of possible client locations and the expected performance associated with these parameter settings. The preceding items may be stored in a table or using any other data structure, as readily contemplated by one of ordinary skill in this and related arts, while maintaining the spirit of the present principles. Hence, in an embodiment, the memory may be used to store the database referred to herein with respect to the server 100. Given the teachings of the present principles provided herein, one of ordinary skill in this and related arts will contemplate these and other variations and implementations of the present principles, while maintaining the spirit of the present principles.

In the operational phase, each mobile client 131 gets from the server 110 a resource parameter map and the expected performance for the client's current location and locations around it where it would reach in the next few seconds or minutes. The resource parameter map may include one or more resource parameter settings determined by the mobile client 131 or other mobile clients. For each location, the client 131 first tries out the parameter settings included in the map. If the performance is not close to the expected performance, then it will tune diversity, directionality or bit rate to improve the performance. If performance is improved, the new resource parameter settings are given to the server 110 for updating the database. The server 110 may choose to replace the old settings for the location with the new ones, or combine the old and the new ones. In an embodiment, the combining of the old and the new setting may be based upon some type of averaging such as exponentially weighted averaging. This choice is implementation specific Of course, given the teachings of the present principles provided herein, it is to be appreciated that other mathematical operations may be used to combine in addition to or in place of averaging, as readily contemplated by one of ordinary skill in this and related arts, while maintaining the spirit of the present principles.

FIG. 2 shows the exploration phase 200 of the client 131, in accordance with an embodiment of the present principles. The exploration phase 200 involves the client 131, the server 110, and the set of receivers 140. At step 205, the client 131 obtains parameters for a current location, and sends the obtained parameters to the server 110. At step 210, the server 110 sends the client an instruction to try out a set of parameters that the server 110 wishes to learn about. The parameters in the set may include, but are not limited to, a list or specification of one or more receivers (e.g., a best subset of the set of receivers 140), the locations of these receivers, and an appropriate bit rate for these receivers. In an embodiment, the server 110 may, along with the instruction, optionally sends one or more parameters from the set if the client does not already have these parameters. It is to be appreciated that a check list or other means may be used to determine what the client 131 already has knowledge of with respect to the parameters in the set or, in the set of parameters may automatically be transmitted without such a check. Given the teachings of the present principles provided herein, these and other variations with respect to how the client 131 becomes aware of the set of parameters are readily contemplated by one of ordinary skill in this and related arts, while maintaining the spirit of the present principles. For example, in place of sending an explicit instruction, one or more parameters may simply be sent from the server 110 to the client 131, where the instruction is implicit given the transmission and receipt of such parameters.

At step 215, the client 131 then uses one or more parameters from the set and measures the uplink throughput corresponding to such use.

At step 220, packets that are received at all the receivers 140 are combined. It is to be appreciated that the measurements performed with respect to step 215 may be based, at least in part, on the combining of packets as per step 220.

At step 225, the client 131 sends the measurements to the server 110.

At step 230, the server 110 updates the database based on the measurements.

FIG. 3 shows the operational phase 300 of the client 131, in accordance with an embodiment of the present principles. In the operational phase, the basing of adaptation decisions on measured SNR and PER enables the uplink robustness. For example, while SNR captures the average link quality and hence maps to the highest bit rate appropriate at the location, PER captures the variance in the link quality due to channel fluctuations. The intent of the operational phase 300 is to obtain an optimized set of parameters that provide an optimized uplink throughput as compared to simply using fixed parameters, let alone fixed parameters without adaptation.

The operational phase 300 involves the client 131, the server 110, and the set of receivers 140. At step 305, the client 131 requests from the server 110 parameters for at least a current location. At step 310, the server 110 sends each client 131 a resource parameter map and the expected performance for the client's current location and locations around (proximate to) the current location that it would reach in a pre-determined time period (e.g., one or more seconds, one or more minutes and or portions thereof, and so forth). At step 315, for each location, the client 131 first tries out the parameter settings included in the map and measures the corresponding uplink throughput. At step 220, packets that are received at all the receivers 140 are combined. It is to be appreciated that the measurements performed with respect to step 315 may be based, at least in part, on the combining of packets as per step 320. At step 325, it is determined whether or not the measured uplink throughput is acceptable (for example, with respect to the expected performance sent from the server 100). If so, the operational phase 200 continues to step 330. Otherwise, the operational phase 200 returns to step 315. At least the following steps 325, 330, 335, 340, 355, 360, and 365 correspond to run-time adaptation in accordance with an embodiment of the present principles. However, it is to be appreciated that given the teachings of the present principles provided herein, one of ordinary skill in this and related arts will contemplate these and variations of adaptation steps that may be performed in order to dynamically improve uplink throughput performance, while maintaining the spirit of the present principles.

At step 330, it is determined whether or not the PER for the measured uplink throughput (i.e., for the parameters used to obtain such measured uplink throughput) is less than a first threshold (thresh1). If so, then the operational phase 300 continues to step 335. Otherwise, the operational phase 300 returns to step 315.

At step 335, it is determined whether or not the SNR for the measured uplink throughput (i.e., for the parameters used to obtain such measured uplink throughput) is less than a third threshold (thresh3). if so, then the operational phase 300 continues to step 340. Otherwise, the operational phase 300 returns to step 315.

At step 340 the bit rate is increased. At step 345, the parameters are updated. At step 350, a new location is determined to be processed, where the operational phase 300 then returns to step 305.

At step 355, it is determined whether or not the SNR for the measured uplink throughput (i.e., for the parameters used to obtain such measured uplink throughput) is less than a second threshold (thresh2). If so, then the operational phase 300 continues to step 360. Otherwise, the operational phase 300 continues to step 365.

At step 360, the directionality is increased or the rate is reduced.

At step 365, the diversity is increased or the rate is reduced.

At step 370, the database is updated.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

While the prior art has separately used each of directionality and diversity in isolation to increase the mobile uplink as described above, it is to be appreciated that combining directionality and diversity is non-trivial due to conflicting parameter settings required to achieve the best of each approach. For instance, directionality stipulates using as narrow a beam as possible for higher gains while diversity requires the opposite. Further, high-speed mobility and real-world situations such as shadowing and lack of line-of-sight (LOS) require agile solutions that choose between these choices in an informed manner at run-time.

To address the tradeoff effectively, we propose a learning based approach, wherein the server maintains a database of information for each client location of (1) the best subset of receivers and their positions, and (2) the appropriate bit rate for the given subset of receivers. For the subset of receivers, based on its position and the positions of the receivers, the client determines an optimal beam using multiple antenna technology. If the settings do not meet the expected performance due to momentary fluctuations, the client performs further run-time adaptation to tune the parameters. If successful in improving the performance further, the client updates the server with new resource parameter settings.

The present principles are based in part on an evaluation using two vehicular test beds, with the client being a moving car and the receivers being statically placed adjacent to the road on which the car moves. Our evaluation results show that the present principles come close to the optimal solution in most locations, and are significantly better than using just directionality or diversity in isolation (i.e., an increase is uplink throughput is obtained).

A description will now be given regarding an analysis of directionality versus diversity.

Herein, using a simple analytical model, we identify the existence of a fundamental tradeoff between exploiting directionality gain and diversity gain: (1) the parameter settings needed for best directionality and best diversity gains are conflicting; and (2) each option provides gains under different link conditions but neither option is sufficient in isolation.

A description will now be given regarding the analytical model with respect to link throughput.

For communications with a directional antenna, if we assume that the packet error rate (PER) on a link is p, the number of antenna elements is K and the signal-to-interference-and-noise-ratio (SINR) on the link is ρ, then the maximum link throughput (in bits/second) that can be achieved (based on Shannon's channel capacity model) is as follows:

$$\begin{matrix}{T}_{direction} = ( 1 - p ) \cdot {log}_{2} ( 1 + ( K \cdot ρ ) ) & ( 1 ) \\ \approx ( 1 - p ) \cdot {log}_{2} ( K \cdot ρ ) & ( 2 )\end{matrix}$$

If we now assume that the link under consideration can leverage the available receiver diversity (l receivers per sector) by widening its beam width (and hence reducing the number of antenna elements used by a factor of β), and if β₁ is the factor by which the number of receivers increase, then the following applies:

$${T}_{diversity} \approx ( 1 - {p}^{{β}_{1} \cdot l} ) \cdot {log}_{2} ( \frac{K \cdot ρ}{β} ) \qquad ( 3 )$$

From Equations (2) and (3), throughput gain of diversity over directionality is as follows:

$$\begin{matrix}Gain = \frac{{T}_{diversity} - {T}_{direction}}{{T}_{direction}} & ( 4 ) \\ = \frac{( 1 - {p}^{{β}_{1} \cdot l} ) {log}_{2} ( \frac{K \cdot ρ}{β} )}{( 1 - p ) \cdot {log}_{2} ( K \cdot ρ )} - 1 & ( 5 )\end{matrix}$$

The purpose of Equation (5) is to help determine whether there are “regions”, i.e. likely real-world scenarios based on the possible range of link qualities (PER and SNR values), where the choice alternates between directionality and diversity. To do so, we parametrize this model next.

A description will now be given regarding model parameterization and corresponding results.

We now study the effect of different parameters on throughput gain of diversity over directionality (Equation (5)). Specifically, we vary the following:

(1) SNR (values of 25 dB (good channel), 15 dB (modest channel), and 5 dB (poor channel) used);

(2) PER (20%, 40%, and 60%); and

(3) Factor by which number of receivers increase as the beam width is increased (β₁).

Based on experiments and evaluations relating to showing link throughput gain with diversity over directionality as a function of (β₁), where different <SNR, PER> values were used but the number of antenna elements (K) and receivers per beam (l) were kept unchanged, we have arrived at some observations as follows.

One observation is that link throughput gain is significantly affected by PER, namely as PER increases, gain increases. This result is consistent across SNR values, which implies that a link should aim to achieve greater diversity beyond a certain PER threshold as directionality is no longer going to help improve link quality. Also, for a particular PER, gain saturates beyond a certain number of receivers (β₁). Further, the value of β₁ at which gain saturates is a function of the PER, namely the higher the PER, the higher the β₁ required. This result explains why certain wireless systems provide no more improvement with macro-diversity beyond a certain number of receivers (e.g., for cellular systems, diversity gains beyond three receivers are negligible). The average PERs in these systems are maintained below a certain value, which in turn, influences the maximum achievable diversity gains.

Another observation is that link throughput gain reduces with reducing SNR. This implies that, at low SNRs, the link would benefit from increased directionality as opposed to diversity. Note that the PER threshold over which diversity provides gains is SNR-dependent.

Based on investigating the effect of the number of antenna elements (K) and the number of receivers per sector, we find that they have marginal effect on performance and on our observations. Thus, we conclude based on our model that there exists a tradeoff between directionality and diversity and that either choice in isolation is not applicable across the range of different link conditions (PER and SNR values) that are likely to be encountered in real world situations.

We present a system and methods that intelligently combine directionality, diversity and bit rate adaptation to maximize the uplink throughput of a mobile client. Advantageously, we use a long-term location-based learning approach to rapidly choose appropriate parameters for a client at a given location, and optionally apply short-term adaptation to locally tune the algorithm for better throughput. Hereinafter, we first describe the challenges in jointly tuning the parameters—directionality, diversity and bitrate, and then present our algorithms.

A description will now be given of some of the challenges present in combining directionality with diversity.

Our goal is to jointly tune directionality, diversity and bit rate selection for maximizing the uplink throughput of a client. These options have conflicting parameter settings, hence making the problem of jointly tuning the options non-trivial for the following reasons.

One reason the problem of jointly tuning the options is non-trivial relates to obtaining the best diversity gains. The larger the number of receivers, the better the benefits of diversity. Covering a larger number of receivers naturally engenders using the widest possible beam width (omni-directional being the extreme) for transmission at the client. However, the larger the beam width, the lower the gain in any direction, and hence, the lower the SNR at a receiver.

Another reason the problem of jointly tuning the options is non-trivial relates to the best directionality gains. The thinner the beam width used by the client, the higher is the signal gain and, hence, the higher the benefit of directionality. Increased SNR on the link also allows using higher bit rates for transmissions. However, this also implies that using highly directional beams reduces the number of receivers available for obtaining diversity gains.

Yet another reason the problem of jointly tuning the options is non-trivial relates to the best bit rate gains. The higher the bit rate, the better the throughput gains on a link. For achieving a high bit rate, however, the SNR on a link should be high enough to cross a certain threshold. Consequently, among a set of receivers that are used for diversity, the receiver with the minimum SNR controls the rate at which packets should be sent to be successfully decodeable at all the receivers.

Due to these tradeoffs, the goal of a good algorithm for such a setting is to strike the right tradeoff by tuning the parameters appropriately.

A description will now be given regarding exemplary approaches for tuning the parameters for combining directionality and diversity.

For a client at a given location that intends to do uplink transmission, our goal is to choose a set of receivers, form a transmit beam that covers all the receivers, and choose a bit rate that is appropriate to make packets decodeable at all the receivers. Our approach includes infrastructure support for learning and storing the resource parameter settings at a given location. This is based on the hypothesis that the resource parameter settings that achieve high throughput at a geographic location remain almost the same unless the access point placement changes, or new access points are added to the network. Further, the parameters remain the same across several clients that pass through the same location, as long as the client resources and parameters (such as transmit power used, number of antenna elements, and so forth) are homogeneous. Hence, the settings learnt from one client can be used by others at the same location.

We employ a server 110 that is accessible through the infrastructure via a control plane, and that provides a map of resource parameter settings for a set of locations that the client may pass (e.g., a set of road segments) during its mobility. We assume that each client 131 incorporates two phases, namely an exploration phase and an operational phase, during the time it traverses a set of locations. In the exploration phase, the server 110 instructs the client 131 to try out a set of parameters that the server 110 wishes to learn about and report back the uplink throughput obtained. This information is used by the server 110 to populate the database (included therein) that includes the best parameter settings for each geographical location.

In the operational phase, the adaptation algorithm on the client 131 does two functions. Firstly, at each new location, it uses the settings suggested by the server 110 for transmission. The server 110 chooses the settings that are the best in terms of throughput among the settings that are tried across clients in different exploration phases. The map of expected throughput at each location is also given to the client 131 by the server 110. Second, at an existing location, the algorithm periodically (every few packets or every few units of time) monitors the performance obtained by the client 131, and compares the same with the expected throughput. If the current conditions depict that the resource parameters are under-performing, then the algorithm performs further run-time adaptation to better tune the parameters.

TABLE 1

PER

| SNR | High | Low |
|---|---|---|
| High | ↑ Diversity | ↑ Rate |
| | or ↓ Rate | |
| Low | ↑ Directionality | Do nothing |
| | or ↓ Rate | |

Run-time adaptation performed by the client 131 can be easily understood by looking at TABLE 1. TABLE 1 shows parameters relating to run-time adaptation, in accordance with an embodiment of the present principles. In an embodiment, the goal of this adaptation is to maintain the link at as high a rate as possible by first adapting directionality and diversity, and performing rate adaptation only when neither directionality nor diversity can help improve the PER. Of course, the present principles are not limited to the preceding approach as far as performing directional and diversity adaptation first and conditionally performing rate adaptation and, thus, other approaches as far as which are performed first, if any, and in what order, if any, may be used, while maintaining the spirit of the present principles. A consideration in using this table is that the reduction in uplink throughput for a client manifests as variations in SNR and PER. If we consider the current resource parameter settings as a state, then the next state we transition to depends on whether SNR and PER are high or low compared to a threshold. If SNR is already high and crosses the required threshold for packet decodeability, and PER is still high, then increasing diversity by adding additional receivers is a better option than increasing directionality. However, if the SNR is low and PER is high, there is an increased chance of making some of the existing links to the receivers better by increasing directionality. If the PER is low, however, the client tries to increase the rate to obtain better throughput.

The client 131 reports back to the server 110 the new resource parameter settings for inclusion into the database. In an embodiment, the server 110 uses a weighted moving average of the updates to resource parameters to ensure that a single observation due to momentary fluctuations will not change the settings significantly.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. An apparatus in a mobile client, comprising:
an antenna for transmitting and receiving wireless signals; and
an uplink connectivity manager for dividing an uplink transmission for each client location into an exploration phase and an operational phase.

2. The apparatus of claim 1, wherein the exploration phase involves the mobile client trying various parameter settings for the uplink transmission for each client location, estimating an uplink throughput performance associated with the various parameter settings, and reporting the estimated uplink throughput performance to another entity.

3. The apparatus of claim 2, wherein the operational phase involves the mobile client trying parameter settings from among a parameter settings set for the uplink transmission for each client location, and performing parameter adaptation of at least one parameter setting from among the parameter settings set to obtain an optimized uplink throughput, wherein each of the parameter settings in the parameter settings set are determined to be the best available based on one or more thresholds.

4. The apparatus of claim 2, wherein the operational phase involves the mobile client receiving, from the other entity, a set of location-specific parameter settings and expected performance for at least a current location based on the set, trying at least some parameter settings in the set, and performing parameter adaptation to obtain an optimized uplink throughput responsive to an actual performance not corresponding to the expected performance as determined using one or more thresholds, wherein each of the parameter settings in the set are determined to be the best available based on one or more thresholds.

5. The apparatus of claim 4, wherein the set of location-specific parameter settings received from the other entity comprise, for the each client location, a bit rate, a set of receivers, and receiver locations.

6. The apparatus of claim 4, where the mobile client tries out at least some parameter settings in the set by measuring a signal-to-noise ratio and a packet error rate periodically for a set of packets, and
if the packet error rate is less than a PER threshold, the signal-to-noise ratio is higher than a first signal-to-noise ratio threshold, and a higher bit rate than a currently used bit rate by the mobile client is available, then the currently used bit rate is increased to the higher bit rate and the higher bit rate is reported to the other entity responsive to the packet error rate still being less than the PER threshold when the higher bit rate is used by the mobile device,
if the packet error rate is greater than the packet error rate threshold, the signal-to-noise ratio is greater than a second signal-to-noise ratio threshold, then increase diversity by adding one or more receivers and forming a beam that encompasses, among other receivers, the added one or more receivers or reduce the bit rate when no receivers are available to be added; and
if the packet error rate is greater than the packet error rate threshold, the signal-to-noise ratio is less than the second signal-to-noise ratio threshold, and the mobile client is currently using more than one receiver, then increase directionality by omitting from use at least one receiver and forming a beam that encompasses a reduced number of receivers with respect to the at least one omitted receiver or reduce the bit rate when the mobile client is currently using only one receiver.

7. A system, comprising:
one or more mobile clients, each having an uplink connectivity manager for dividing an uplink transmission for each client location into an exploration phase and an operational phase; and
a server for providing support to the one or more mobile devices with respect to the exploration phase and the operational phase, by at least receiving an estimated uplink throughout performance, for each client location, as reported by each of the one or more mobile clients with respect to the exploration phase, and indicating to each of the one or more mobile clients a respective parameter settings set to try at at least a current location with respect to the operational phase, wherein each of parameter settings in the respective parameter settings set are determined to be the best available based on one or more thresholds.

8. The apparatus of claim 7, wherein the exploration phase involves each of the one or more mobile clients trying various parameter settings for the uplink transmission for each client location, estimating the uplink throughput performance associated with the various parameter settings, and reporting the estimated uplink throughput performance to the server.

9. The apparatus of claim 8, wherein the operational phase involves each of the one or more mobile clients trying parameter settings from among a parameter settings set for the uplink transmission for each client location, and performing parameter adaptation of at least one parameter setting from among the parameter settings set to obtain an optimized uplink throughput.

10. The apparatus of claim 8, wherein the operational phase involves each of the one or more mobile clients receiving, from the server, a respective set of location-specific parameter settings and expected performance for at least a current location based on the set, trying at least some parameter settings in the set, and performing parameter adaptation to obtain an optimized uplink throughput responsive to an actual performance not corresponding to the expected performance as determined using one or more thresholds.

11. The apparatus of claim 10, wherein the set of location-specific parameter settings and the expected performance are further for locations proximate to the current location that may be reached by the mobile client within a pre-determined amount of time.

12. The apparatus of claim 10, wherein the set of location-specific parameter settings received from the server comprise, for the each client location, a bit rate, a set of receivers, and receiver locations.

13. The apparatus of claim 10, where the one or more mobile clients try out at least some parameter settings in the set by measuring a signal-to-noise ratio and a packet error rate periodically for a set of packets, and
if the packet error rate is less than a PER threshold, the signal-to-noise ratio is higher than a first signal-to-noise ratio threshold, and a higher bit rate than a currently used bit rate is available, then the currently used bit rate is increased to the higher bit rate and the higher bit rate is reported to the server responsive to the packet error rate still being less than the PER threshold when the higher bit rate is used,
if the packet error rate is greater than the packet error rate threshold, the signal-to-noise ratio is greater than a second signal-to-noise ratio threshold, then increase diversity by adding one or more receivers and forming a beam that encompasses, among other receivers, the added one or more receivers or reduce the bit rate when no receivers are available to be added; and
if the packet error rate is greater than the packet error rate threshold, the signal-to-noise ratio is less than the second signal-to-noise ratio threshold, and currently more than one receiver is being used, then increase directionality by omitting from use at least one receiver and forming a beam that encompasses a reduced number of receivers with respect to the at least one omitted receiver or reduce the bit rate when only one receiver is currently being used.

14. A method performed in a wireless network having one or more mobile clients and a server, the method comprising
dividing, in each of the one or more mobile clients, an uplink transmission for each client location into an exploration phase and an operational phase; and
providing support to the one or more mobile devices by the server with respect to the exploration phase and the operational phase, by at least receiving an estimated uplink throughout performance, for each client location, as reported by each of the one or more mobile clients with respect to the exploration phase, and indicating to each of the one or more mobile clients a respective parameter settings set to try at at least a current location with respect to the operational phase, wherein each of parameter settings in the respective parameter settings set are determined to be the best available based on one or more thresholds.

15. The method of claim 14, wherein the exploration phase involves each of the one or more mobile clients trying various parameter settings for the uplink transmission for each client location, estimating the uplink throughput performance associated with the various parameter settings, and reporting the estimated uplink throughput performance to the server.

16. The method of claim 15, wherein the operational phase involves each of the one or more mobile clients trying parameter settings from among a parameter settings set for the uplink transmission for each client location, and performing parameter adaptation of at least one parameter setting from among the parameter settings set to obtain an optimized uplink throughput.

17. The method of claim 15, wherein the operational phase involves each of the one or more mobile clients receiving, from the server, a respective set of location-specific parameter settings and expected performance for at least a current location based on the set, trying at least some parameter settings in the set, and performing parameter adaptation to obtain an optimized uplink throughput responsive to an actual performance not corresponding to the expected performance as determined using one or more thresholds.

18. The method of claim 17, wherein the set of location-specific parameter settings and the expected performance are further for locations proximate to the current location that may be reached by the mobile client within a pre-determined amount of time.

19. The method of claim 17, wherein the set of location-specific parameter settings received from the server comprise, for the each client location, a bit rate, a set of receivers, and receiver locations.

20. The method of claim 17, where the one or more mobile clients try out at least some parameter settings in the set by measuring a signal-to-noise ratio and a packet error rate periodically for a set of packets, and
if the packet error rate is less than a PER threshold, the signal-to-noise ratio is higher than a first signal-to-noise ratio threshold, and a higher bit rate than a currently used bit rate is available, then the method comprises increasing the currently used bit rate to the higher bit rate and reporting the higher bit rate to the server responsive to the packet error rate still being less than the PER threshold when the higher bit rate is used,
if the packet error rate is greater than the packet error rate threshold, the signal-to-noise ratio is greater than a second signal-to-noise ratio threshold, then the method comprises increasing diversity by adding one or more receivers and forming a beam that encompasses, among other receivers, the added one or more receivers or reducing the bit rate when no receivers are available to be added; and
if the packet error rate is greater than the packet error rate threshold, the signal-to-noise ratio is less than the second signal-to-noise ratio threshold, and currently more than one receiver is being used, then the method comprises increasing directionality by omitting from use at least one receiver and forming a beam that encompasses a reduced number of receivers with respect to the at least one omitted receiver or reducing the bit rate when only one receiver is currently being used.
